(19) United States
(12) Patent Application Publication
(10) Pub. No.: US 2016/0100106 A1
(43) Pub. Date: Apr. 7, 2016

(54) SYSTEM FOR CAMERA SWITCHING ON A MOBILE DEVICE

(71) Applicant: Xiaomi Inc., Beijing (CN)

(72) Inventors: Xinming SHI, Beijing (CN); Hao Di, Beijing (CN); Peng Zhang, Beijing (CN)

(73) Assignee: Xiaomi Inc., Beijing (CN)

(21) Appl. No.: 14/968,559

(22) Filed: Dec. 14, 2015

Related U.S. Application Data
(63) Continuation-in-part of application No. PCT/CN2015/071258, filed on Jan. 21, 2015.

(30) Foreign Application Priority Data
Aug. 15, 2014 (CN) 201410401892.6

(51) Int. Cl. H04N 5/232; H04N 5/225

(52) U.S. Cl. CPC H04N 5/23245; H04N 5/23216; H04N 5/2258

(57) ABSTRACT

Examples herein provide alternative systems for switching cameras on a mobile device. A method of the systems can include receiving, at control circuitry of a mobile device, user-inputted instructions to activate a first camera of the mobile device, so that the first camera is operable to capture an image. The method can also include receiving touch instructions from a touchscreen of the mobile device indicative of a user interaction with the touchscreen. The method can also include determining whether the user interaction with the touchscreen matches one of a set of user interactions with the touchscreen indicative of activating a second camera and deactivating the first camera. The method can also include activating the second camera and deactivating the first camera, where the user interaction matches the one of the set of user interactions.

### CROSS-REFERENCE TO RELATED APPLICATIONS/INCORPORATION BY REFERENCE

This application is a continuation-in-part of International Application No. PCT/CN2015/071258 with an international filing date of Jan. 21, 2015, which is based upon and claims priority to Chinese Patent Application No. 201410401892.6, filed Aug. 15, 2014, the entire contents of which are incorporated herein by reference.

### TECHNICAL FIELD

The present disclosure relates to a system for switching cameras on a mobile device.

### BACKGROUND

A mobile device (such as a smart phone or a tablet computer) can be equipped with a front-facing camera and a rear-facing camera. A user may use the front-facing camera for a selfie and use the rear-facing camera for photographing scenery and the like. In this way, the user may want to switch the cameras of the mobile device frequently. For example, when the user uses the front-facing camera for selfie and then wants to use the rear-facing camera to photograph scenery, the user may want to switch the active camera from the front-facing camera to the rear-facing camera.

In known examples, to switch between cameras on a mobile device, a user can click on an icon linked to a camera switching mechanism. For example, when the user wants to switch the active camera, the user holds the mobile device with one hand and taps the icon linked to the switching mechanism with the other hand. After receiving the user instructions for the switching mechanism, via the designated icon, the mobile device can switch from one camera to another by deactivating the active camera and activating the inactive camera.

### SUMMARY

Examples herein provide alternative systems for switching cameras on a mobile device. For example, one of the systems provides a particular method for switching between cameras of a mobile device. That particular method includes receiving, at control circuitry of a mobile device, user-inputted instructions to activate a first camera of the mobile device, so that the first camera is operable to capture an image. The method also includes receiving, at the control circuitry, touch instructions from a touchscreen of the mobile device indicative of a user interaction with the touchscreen that does not correspond to an icon or another type of graphical element displayed proximate to the gesture. The method also includes determining, by the control circuitry, whether the user interaction with the touchscreen matches one of a set of user interactions with the touchscreen indicative of activating a second camera and deactivating the first camera. In such an example, the set of user interactions may be stored in a memory device of the mobile device. The method also includes activating, by the control circuitry, the second camera and deactivating the first camera, where the user interaction matches the one of the set of user interactions with the touchscreen indicative of activating the second camera and deactivating the first camera. This last operation provides an active second camera that is operable to capture an image and an inactive first camera that is not operable to capture an image.

This summary and the following detailed descriptions are merely exemplary and do not limit the present disclosure.

### BRIEF DESCRIPTION OF THE DRAWINGS

Non-limiting and non-exhaustive examples are described with reference to the following figures. The components in the drawings are not necessarily to scale, and like referenced numerals designate corresponding parts throughout the different views.

FIGS. 1-3 are flow charts illustrating example operations of example systems for switching between cameras on a mobile device.

FIG. 4 is a block diagram illustrating an example electronic device associated with operations of example systems for switching between cameras on a mobile device, such as the operations illustrated in FIGS. 1-3.

### DETAILED DESCRIPTION

Subject matter described herein is intended to be construed as not being limited to examples set forth herein; examples are provided merely to be illustrative. The following detailed description is not intended to be limiting on the scope of what is claimed.

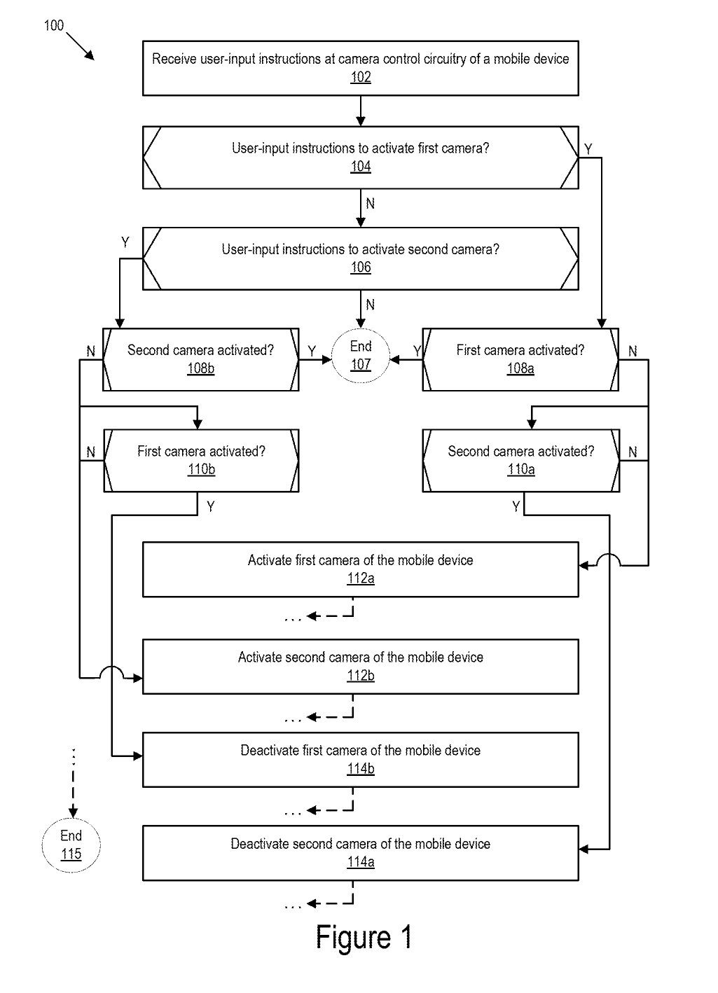

FIG. 1 is flow chart illustrating example operations 100 of an example system for switching between at least first and second cameras on a mobile device. The operations may begin at 102 with camera control circuitry of the mobile device receiving user-inputted instructions. At 104 of the operations 100, the camera control circuitry can determine whether user-input instructions include instructions to activate the first camera. If the user-input instructions do not include instructions to activate the first camera, the camera control circuitry can determine whether user-input instructions include instructions to activate the second camera at 106. Where the user-input instructions do not include instructions to activate the second camera, the camera control circuitry can end the operations 100 at 107.

Where the user-input instructions include instructions to activate the first camera, the camera control circuitry can determine if the first camera is activated at 108a. If the first camera is activated, the camera control circuitry can end the operations 100 at 107. If the first camera is activated, the camera control circuitry can determine if the second camera is activated at 110a and/or activate the first camera at 112a. If it is determined that the second camera is not activated at 110a, the camera control circuitry can still activate the first camera at 112a. If it is determined that the second camera is activated at 110a, the camera control circuitry can deactivate the second camera 114a. This deactivation can occur before or after the activation of the first camera. Alternatively, the deactivation of the second camera can overlap the activation of the first camera. Finally, after the first camera is activated and the second camera is deactivated, or at least the first camera is activated, the operations 100 end at 115.

Where the user-input instructions include instructions to activate the second camera, the camera control circuitry can determine if the second camera is activated at 108b. If the second camera is activated, the camera control circuitry can end the operations 100 at 107. If the second camera is activated, the camera control circuitry can determine if the first camera is activated at 110b and/or activate the second camera at 112b. If it is determined that the first camera is not activated at 110b, the camera control circuitry can still activate the second camera at 112b. If it is determined that the first camera is activated at 110b, the camera control circuitry can deactivate the first camera 114b. This deactivation can occur before or after the activation of the second camera. Alternatively, the deactivation of the first camera can overlap the activation of the second camera. Finally, after the second camera is activated and the first camera is deactivated, or at least the second camera is activated, the operations 100 end at 115.

In an example, such operations may begin with camera control circuitry of the mobile device receiving user-inputted instructions to activate a first camera of the mobile device, so that the first camera is operable to capture an image. For example, the control circuitry can receive touch instructions from a touchscreen of the mobile device indicative of a user interaction with the touchscreen that does not correspond to an icon or another type of graphical element displayed proximate to the gesture. The control circuitry can also determine whether the user interaction with the touchscreen matches one of a set of user interactions with the touchscreen indicative of activating a second camera and deactivating the first camera. The set of user interactions can be stored in a memory device of the mobile device. The control circuitry can also activate the second camera and deactivate the first camera, where the user interaction matches the one of the set of user interactions with the touchscreen indicative of activating the second camera and deactivating the first camera. This provides for the second camera to be operable to capture an image and the first camera to not be operable to capture an image.

In an example, the touch instructions are first touch instructions and the user interaction is a first user interaction. In such an example, the operations can include receiving, at the control circuitry, second touch instructions from the touchscreen of the mobile device indicative of a second user interaction with the touchscreen that does not correspond to an icon or another type of graphical element displayed proximate to the gesture. The operations can also include determining, by the control circuitry, whether the second user interaction with the touchscreen matches one of the set of user interactions with the touchscreen indicative of activating the first camera and deactivating the second camera. The operations can also include activating, by the control circuitry, the first camera and deactivating the second camera, so that the first camera is operable to capture an image and the second camera is not operable to capture an image. This can occur where the user interaction matches the one of the set of user interactions with the touchscreen indicative of activating the first camera and deactivating the second camera.

In an example, the one of the set of user interactions with the touchscreen indicative of activating the second camera and deactivating the first camera and the one of the set of user interactions with the touchscreen indicative of activating the first camera and deactivating the second camera are similar user interactions. For example, the one of the set of user interactions with the touchscreen indicative of activating the second camera and deactivating the first camera and the one of the set of user interactions with the touchscreen indicative of activating the first camera and deactivating the second camera include a vertical swipe across the touchscreen. In another example, the one of the set of user interactions with the touchscreen indicative of activating the second camera and deactivating the first camera and the one of the set of user interactions with the touchscreen indicative of activating the first camera and deactivating the second camera are different user interactions.

In another example, the one of the set of user interactions with the touchscreen indicative of activating the second camera and deactivating the first camera includes continually touching the touchscreen for at least a certain duration of time. In yet another example, the one of the set of user interactions with the touchscreen indicative of activating the second camera and deactivating the first camera includes touch gesturing a two-dimensional shape on the touchscreen. In yet another example, the one of the set of user interactions with the touchscreen indicative of activating the second camera and deactivating the first camera includes a certain frequency of touches at a same portion of the touchscreen.

In yet another example, the one of the set of user interactions with the touchscreen indicative of activating the second camera and deactivating the first camera includes a swipe on the touchscreen. In such an example, the swipe can include at least a certain length, a certain portion of the touchscreen, a certain direction.

In yet another example, a user may perform a touch operation matched with the set touch operation on a touchscreen to trigger the terminal to switch the cameras, which includes the user holding the mobile device by one hand, and meanwhile, the user moving one finger of the hand, such as the thumb, to perform the touch operation matched with the set touch operation on the touchscreen. This and the aforementioned techniques allow for single-handed switching between cameras.

In yet another example the one of the set of user interactions with the touchscreen indicative of activating the second camera and deactivating the first camera, the one of the set of user interactions with the touchscreen indicative of activating the first camera and deactivating the second camera, or both are configurable by a user of the mobile device. For example, prior to the camera-switching operations, a user may input a specific touch operation or a touch operation type at a configuration screen of the mobile device.

The mobile device may be any mobile device equipped with a first camera and a second camera. For example, the mobile device may be a mobile phone or a tablet personal computer equipped with a first camera and a second camera. In an instance, the first camera may be either a front-facing camera or a rear-facing camera. For example, the mobile device acquires operation instructions for turning on the front-facing camera, and turns on the front-facing camera. When the user wants to switch turning on the front-facing camera into turning on the rear-facing camera, the user holds the terminal by one hand, and meanwhile, the user may stick out their thumb to perform a touch operation on the screen of the mobile device matched with the set touch operations. The mobile device may monitor the touchscreen for touchscreen interactions in real time.

Also, in an example, when the user wants to switch turning on the front-facing camera into turning on the rear-facing camera, the user may swipe right by 2 cm on the screen of the mobile device by one finger. When the mobile device monitors that the screen of the mobile device acquires the swipe operation or the operation type of the swipe operation is acquired as the swipe operation type.

Also, in an example, where a preset type is a long press operation type, and the operations may include determining whether the operation type of the touch operation is the long press operation type. When it is determined that the operation type of the touch operation is the long press operation type, determining that the operation type of the touch operation is matched with the preset type, otherwise, determining that the operation type of the touch operation is not matched with the preset type. Also, the operation of determining that the operation type of the touch operation is matched with the preset type may include acquiring the time for the user's finger pressing the screen, and determining whether the time for the user's finger pressing the screen conforms to a preset parameter. When it is determined that the time for the user's finger pressing the touchscreen reaches the set time for the long press operation type, the switch determination circuitry can determine the long press operation as an operation that satisfies switching the camera on the mobile device. Otherwise, the control circuitry may determine that the operation type of the touch operation is not matched with the preset type. Also, the operation of determining that the operation type of the touch operation is matched with the preset type may include acquiring a distance for user's finger swiping on the touchscreen, and determining whether the distance for user's finger swiping on the screen conforms to a preset parameter, wherein the preset parameter may be a preset distance. Such an instance may include determining whether the distance for user's finger swiping on the touchscreen reaches the preset distance. When it is determined that the distance for user's finger swiping on the touchscreen reaches the preset distance, determining the swipe operation as an operation that satisfies switching the cameras. Otherwise, the control circuitry determines that the operation type of the touch operation is not matched with the preset type.

Satisfaction of the preset condition for switching cameras may also include receiving touch instructions of a swipe direction of a finger on the touchscreen and determining whether the swipe direction is identical to a preset direction. When it is determined that the swipe direction is identical to the preset direction, the control circuitry can determine that the instructions of the swipe operation satisfy a preset condition. Otherwise, the circuitry determines that the touch operation is not matched with the set touch operation.

Satisfaction of the preset condition for switching cameras may also include receiving a swipe distance and a swipe direction of user's finger on the touchscreen. It may then be determined whether the swipe distance for the user's finger on the touchscreen exceeds a preset distance and whether the swipe direction is within the preset direction. If the swipe distance of user's finger on the touchscreen exceeds the preset distance and the swipe direction is within the preset direction, the circuitry may determine that the instructions of the swipe operation satisfy the preset condition. Otherwise, the circuitry determines that the touch operation is not matched with the set touch operation.

Satisfaction of the preset condition for switching cameras may also include receiving a tap operation type and determining that the operation type of the touch operation is matched with the preset type. Otherwise, it includes determining that the operation type of the touch operation is not matched with the preset type.

Satisfaction of the preset condition for switching cameras may also include, receiving a frequency for user's finger tapping the touchscreen, and determining whether the frequency for user's finger tapping the touchscreen conforms to a preset parameter, wherein the preset parameter may be a preset frequency. When it is determined that the frequency for user's finger tapping the touchscreen reaches the preset frequency, the circuitry may determine the tap operation as an operation that satisfies switching cameras. Otherwise, it may be determined that there is not a match.

In an example, determining the swipe distance of user's finger on the touchscreen may include identifying positions included in a swipe track of user's finger on the touchscreen, calculating distances between every two adjacent points among the positions, and summing up the distances between every two adjacent points as the swipe distance of user's on the screen. In an example, determining the swipe direction of user's finger on the touchscreen may include identifying the swipe track on the touchscreen, the start-point position of the track, and the end-point position of the track. Speed of the swipe may also be considered. A speed may be set and altered according to a manufacturer or a user. The preset distance may also be set and altered according to the size of the touchscreen. A preset frequency may be set and altered according to a user or a developer as well. The preset direction may also be set and altered according to user or developer configurations. For example, the preset direction may be a rightward direction, and the preset distance may be 1 cm and the mobile device may receive that the swipe direction of user's finger on the screen of the mobile device is rightward for 1 cm. Thus, the swipe direction of user's finger on the touchscreen matches to the preset direction. The match does not need to be exact, but can be within a set range. For example, the mobile device receives that the swipe distance of user's the finger on the touchscreen is 2 cm, which exceeds the set distance. Thus, the mobile device determines that the touch operation is matched with the set touch operation as well, because the operations have been configured to accept such a range.

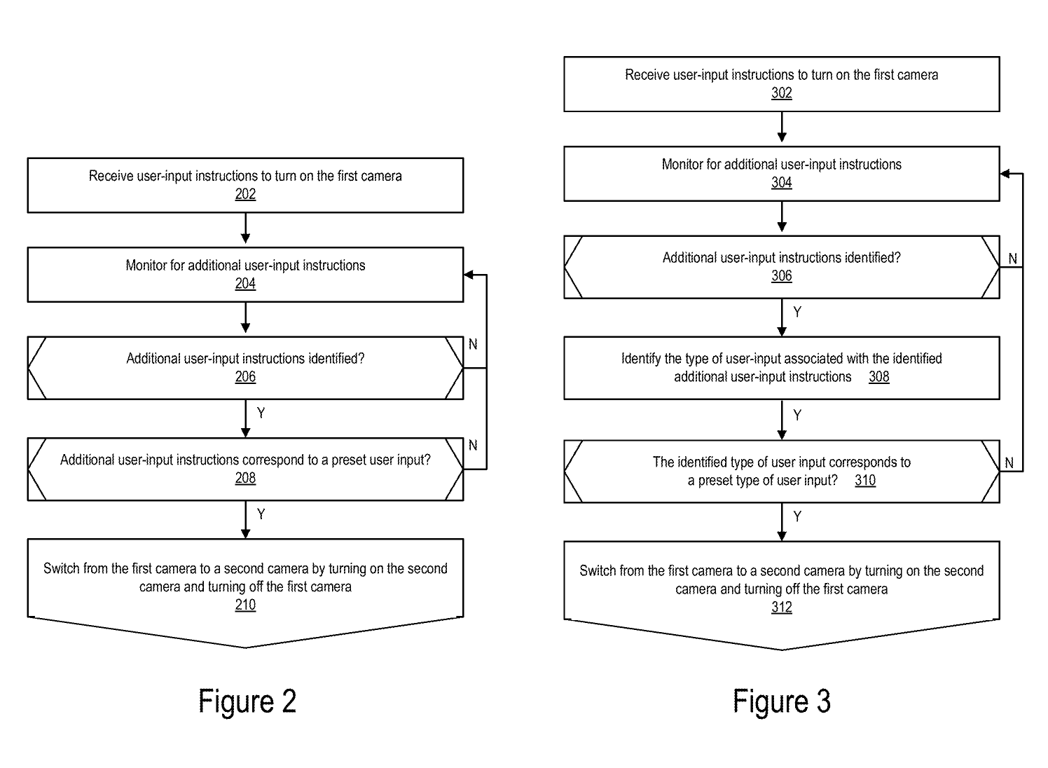

FIGS. 2 and 3 are flow charts illustrating operations 200 and 300 of an example system for switching between at least first and second cameras on a mobile device. These operations may be combined with each other, the operations 100, or any other operations described herein.

FIG. 2 is flow chart illustrating example operations 200 of an example system for switching between at least first and second cameras on a mobile device. The operations may begin at 202 with camera control circuitry of the mobile device receiving user-inputted instructions to turn on the first camera. At 204 of the operations 200, the camera control circuitry can monitor for additional user-input instructions. At 206, it is determined whether additional user-input instructions have been identified by the control circuitry. Where user-input instructions have not been identified by the camera control circuitry, the camera control circuitry continues to monitor for additional user-input instructions. Where user-input instructions have been identified by the camera control circuitry, the camera control circuitry determines whether the additional user-input instructions correspond to a preset user input at 208. Where it is determined that the additional user-input instructions do not correspond to the preset user input, the camera control circuitry continues to monitor for additional user-input instructions. Where it is determined that the additional user-input instructions do correspond to the preset user input, the camera control circuitry turns on the second camera and turns off the first camera at 210.

FIG. 3 is flow chart illustrating example operations 300 of an example system for switching between at least first and second cameras on a mobile device. The operations may begin at 302 with camera control circuitry of the mobile device receiving user-inputted instructions to turn on the first camera. At 304 of the operations 300, the camera control circuitry can monitor for additional user-input instructions. At 306, it is determined whether additional user-input instructions have been identified by the control circuitry. Where user-input instructions have not been identified by the camera control circuitry, the camera control circuitry continues to monitor for additional user-input instructions. Where user-input instructions have been identified by the camera control circuitry, the camera control circuitry identifies the type of user input associated with the identified additional user-input instructions at 308. At 310, it is determined whether the identified type of user input corresponds to a preset type of user input. Where it is determined that the additional user-input instructions do not correspond to the preset type of user input, the camera control circuitry continues to monitor for additional user-input instructions. Where it is determined that the additional user-input instructions do correspond to the preset type of user input, the camera control circuitry turns on the second camera and turns off the first camera at 312.

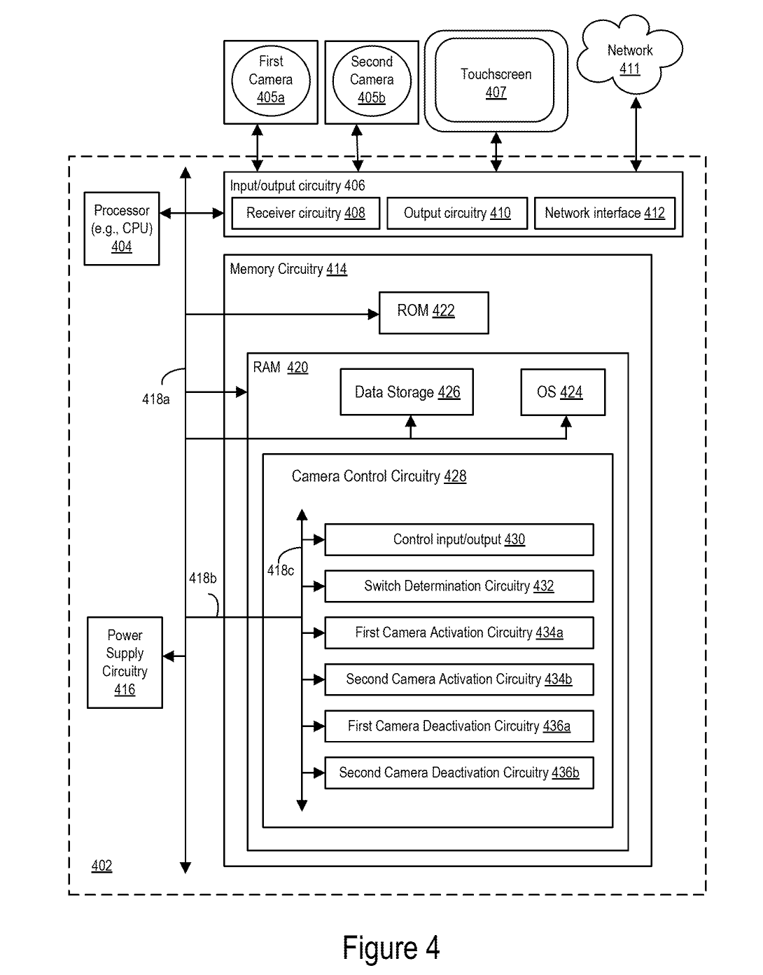

FIG. 4 is a block diagram illustrating an example mobile device 402 including an example system for switching between cameras on the mobile device. Such a system may include circuitries configured to execute the operations illustrated in FIGS. 1-3. The mobile device 402 may be an actual mobile device (such as a smartphone or a tablet computer), any type of personal computer, a digital broadcast terminal (such as a smart TV), a messaging device, a part of a gaming console, a medical device, a part of exercise equipment, and a personal digital assistant, for example. The mobile device 402 includes camera control circuitry 428 (such as the camera control circuitry that can perform the operations 100, 200, and 300). The mobile device 402 also includes input/output circuitry 406, such as receiver circuitry 408 and output circuitry 410. The input/output circuitry also includes a network interface 412. The mobile device 402 also includes a processor 404, memory circuitry 414, a power supply circuitry 416, and a communication buses 418a-418c that connects at least the aforementioned elements of the mobile device.

The processor 404 can be any type of data processing device, such as a central processing unit (CPU). Also, for example, the processor 404 can be central processing logic. The mobile device 402 may also include or at least connect to a display, a touchscreen 407, and first and second digital cameras 405a and 405b. The display may be a part of the touchscreen 407. Each of these components may interact with the camera control circuitry 428 and the processor 404. Also, the processor 404 may control operations of the mobile device 402, such as the operations associated with displayed graphical user interfaces, telephone calls, data communications, camera operations, recording operations, and various types of data processing, such as the operations 100, 200, 300, and other camera switching operations described herein. The processor 404 may also be communicatively coupled to coprocessors.

The memory circuitry 414, which can include random access memory (RAM) 420 or read-only memory (ROM) 422, can be enabled by various types of known memory devices. The RAM 420 can store data and instructions defining an operating system 424, data storage circuitry 426, and camera control circuitry 428. Although in FIG. 4 the camera control circuitry is depicted as a part of the RAM 420, in these examples and others, the camera control circuitry may include hardware (such as microprocessors), firmware, software, or any combination thereof. The ROM 422 can include basic input/output system (BIOS) of the electronic mobile device 402. Aspects of the memory circuitry 414 can store various types of data to support operations of the mobile device 402, such as in the data storage circuitry 426. Examples of such data include instructions for any applications or operations of the mobile device 402, messages, pictures, and video. Aspects of the memory circuitry 414 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), such as ROM 422, a magnetic memory, a flash memory, a magnetic or optical disk, or any combination thereof.

The input/output components can include the interfaces for facilitating communication between any components of the electronic mobile device 402, components of external devices (such as a digital camera, a digital video recorder, a display, or components of other devices of a network 411), and end users. For example, such components can include a network card that is an integration of a receiver, a transmitter, and I/O interfaces. The I/O components can include user interfaces such as monitors, keyboards, touchscreens (such as touchscreen 407), microphones, and speakers. Further, some of the I/O components and the buses 418a-418c can facilitate communication between components of the electronic mobile device 402, and can ease processing performed by the processor 404.

Multimedia devices included in or associated with the mobile device 402 may include a screen providing an output interface between the device and a user. In some examples, the touchscreen 407 may include a liquid crystal display (LCD) and a touch panel (TP). If the touchscreen 407 includes the touch panel, it may be implemented to receive input signals from a user. The touch panel includes one or more touch sensors to sense touches, swipes, and other types of gestures on the touch panel. The touch sensors may not only sense a boundary of a touch or swipe action, but also sense a period of time and a pressure associated with the touch or swipe action.

In some examples, the mobile device may include at least one of a front-facing camera and a rear-facing camera. For example, the first camera 405a may be a front-facing camera and the second camera 405b may be a rear-facing camera, or vice versa. The front-facing camera and/or the rear-facing camera may receive an external multimedia datum while the mobile device 402 is in an operation mode, such as a photographing mode or a video mode. Each of the first camera 405a and the second camera 405b may be a fixed optical lens system or have focus and optical zoom capability.

The mobile device may also include an audio component configured to output and/or input audio signals. For example, an audio component may include a microphone configured to receive an external audio signal when the mobile device 402 is in an operation mode, such as a call mode, a recording mode, and a voice recognition mode. The received audio signal may be further stored in a part of the memory circuitry 414 or transmitted via the network interface 412. In some examples of the mobile device 402, a speaker may be included.

The depicted input/output circuitry of the mobile device 402 may provide an interface between the processor 404 and peripheral interface components, such as a keyboard, a click wheel, and buttons, for example. The buttons may include a home button, a volume button, a starting button, and a locking button.

Sensor components of the mobile device 402 may include one or more sensors to provide status assessments of various aspects of the device. For example, a sensor component may detect an open/closed status of the mobile device 402, relative positioning of the device and its components (e.g., a display and a keypad) of the mobile device 402, a change in position of the device or a component of the device, a presence or absence of user contact with the device, an orientation or an acceleration/deceleration of the device, and a change in temperature of the device. A sensor component may include a proximity sensor configured to detect the presence of nearby objects without any physical contact. A sensor component may also include a light sensor, such as a CMOS or CCD image sensor, for use in imaging applications. In some examples, a sensor component may also include an accelerometer sensor, a gyroscope sensor, a magnetic sensor, a pressure sensor, or a temperature sensor. In some examples, the sensor component may also include an accelerometer sensor, a gyroscope sensor, a magnetic sensor, a pressure sensor, or a temperature sensor. These sensor components and any of the other input/output components described herein (such as the components of the input/output circuitry 406) may be a source of the user-input instructions received in the operations described herein (such as the operations 100, 200, and 300).

The network interface 412 can include a receiver and a transmitter (or a transceiver), and an antenna for wireless communications. The network interface 412 may be configured to facilitate communication, wired or wirelessly, between the mobile device 402 and other devices. The mobile device 402 can access a wireless network (such as a part of the network 411) based on a communication standard, such as WiFi, 2G, or 3G, or a combination thereof. In an example, the network interface 412 may receive a broadcast signal or broadcast associated information from an external broadcast management system via a broadcast channel. Also, the network interface 412 may include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

The power supply circuitry 416 contains power components, and facilitates supply and management of power to the electronic mobile device 402. The power supply circuitry 416 may provide power to various components of the mobile device 402. The power supply circuitry 416 may include a power management system, one or more power sources, and any other components associated with the generation, management, and distribution of power in the mobile device 402.

The aspects of the mobile device 402 described herein may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. Also, aspects may be provided by a non-transitory computer-readable storage medium including instructions, such as included in the memory circuitry 414, executable by the processor 404, for performing operations described herein. For example, the non-transitory computer-readable storage medium may be a ROM, a RAM, a CD-ROM, a magnetic tape, a floppy disc, an optical data storage device, or any combination thereof.

In an example, an I/O component of the mobile device 402, receiver circuitry 408, can be configured to receive image data of an image to be segmented including a background and a face of a person in a foreground. The image data can include data representative of a plurality of pixels of the image and a positioning result of a plurality of exterior contour points of the face. The output circuitry 410 can be configured to communicate the image with the segmented plurality of pixels to display circuitry.

The camera control circuitry 428 is communicatively coupled to the receiver circuitry 408 and the output circuitry 410. The camera control circuitry 428 can include sub-circuitries to perform any of the operations described herein.

In an example (such as the example depicted in FIG. 4), the mobile device 402 includes the touchscreen 407, the first camera 405a, the second camera 405b, a memory device at least including the memory circuitry 414, and the processor 404. Also depicted, the mobile device 402 includes camera control circuitry 428, which is part of the RAM 420. Alternatively, this control circuitry may include at least part of a memory device including the RAM 420 and the processor 404.

Within the camera control circuitry 428, the control input/output circuitry 430 can be configured to receive user-inputted instructions to activate the first camera of the mobile device, so that the first camera is operable to capture an image. For example, the user-inputted instructions to activate the first camera of the mobile device can be indicative of a touchscreen gesture that does not correspond to an icon or another type of graphical element displayed proximate to the gesture. The control input/output circuitry 430 can also be configured to receive touch instructions from the touchscreen 407 indicative of a user interaction with the touchscreen that does not correspond to an icon or another type of graphical element displayed proximate to the gesture.

Within the camera control circuitry 428, the switch determination circuitry 432 can be configured to determine whether the user interaction with the touchscreen 407 matches one of a set of user interactions with the touchscreen indicative of activating the second camera 405b and deactivating the first camera 405a. The set of user interactions may be stored in a memory device such as the RAM 420. In an example, the preset interactions may be stored in the data storage circuitry 426. Besides the aforementioned determination, the switch determination circuitry 432 may perform any of the determinations and identifications described herein related to camera switching.

Within the camera control circuitry 428, the second camera activation circuitry 434b can be configured to activate the second camera, so that the second camera is operable to capture an image. In an example, the first camera is then not operable to capture an image. In such an example, the first camera deactivation circuitry 436a can be configured to deactivate the first camera. This activation and deactivation can occur when the user interaction matches the one of the set of user interactions with the touchscreen indicative of activating the second camera and deactivating the first camera. The matching occurring that the switch determination circuitry 432, for example.

In an example operation performed by the mobile device 402, the aforementioned touch instructions can be first touch instructions and the user interaction can be a first user interaction. In such an example, within the control circuitry, the control input/output circuitry 430 can be configured to receive second touch instructions from the touchscreen 407 indicative of a second user interaction with the touchscreen that does not correspond to an icon or another type of graphical element displayed proximate to the gesture. The switch determination circuitry 432 can determine whether the second user interaction with the touchscreen 407 matches one of the set of user interactions with the touchscreen indicative of activating the first camera 405a and deactivating the second camera 405b. The first camera activation circuitry 434a can be configured to activate the first camera and the second camera deactivate circuitry 436b can be configured to deactivate the second camera, so that the first camera is operable to capture an image and the second camera is not operable to capture an image. These circuitries can operate where the user interaction matches the one of the set of user interactions with the touchscreen indicative of activating the first camera and deactivating the second camera. In such examples, the first camera can be a rear-facing camera and the second camera can be a front-facing camera, or the first camera can be a front-facing camera and the second camera can be a rear-facing camera. Alternatively, the first and second cameras can be rear-facing cameras or the first and second cameras can be front-facing cameras.

Also, the mobile device 402 may include a non-transitory computer readable medium that includes instructions executable by the processor 404 to perform any of the camera switching operations described herein. For example, the non-transitory computer readable medium may include instructions executable by the processor 404 to receive user-inputted instructions to activate the first camera 405a of the mobile device 402, so that the first camera is operable to capture an image. In such an example, the user-inputted instructions to activate the first camera 405a is indicative of a touchscreen gesture that does not correspond to an icon or another type of graphical element displayed proximate to the gesture. The non-transitory computer readable medium may also include instructions executable by the processor 404 to receive touch instructions from the touchscreen 407 that are indicative of a user interaction with the touchscreen that does not correspond to an icon or another type of graphical element displayed proximate to the gesture. The non-transitory computer readable medium may also include instructions executable by the processor 404 to determine whether the user interaction with the touchscreen 407 matches one of a set of user interactions with the touchscreen indicative of activating a second camera 405b and deactivating the first camera 4056a. The set of user interactions may be stored in a memory device of the mobile device (such as a device of the memory circuitry 414). The non-transitory computer readable medium may also include instructions executable by the processor 404 to activate the second camera 405b and deactivate the first camera 405a, so that the second camera is operable to capture an image and the first camera 405a is not operable to capture an image, where the user interaction matches the one of the set of user interactions with the touchscreen 407 indicative of activating the second camera and deactivating the first camera.

Also, in such an example, the touch instructions may be first touch instructions and the user interaction may be a second user interaction. In such an instance, the medium may also include instructions executable by the processor 404 to receive second touch instructions from the touchscreen 407 indicative of a second user interaction with the touchscreen that does not correspond to an icon or another type of graphical element displayed proximate to the gesture. Also, the medium may include instructions executable by the processor 404 to determine whether the second user interaction with the touchscreen 407 matches one of the set of user interactions with the touchscreen indicative of activating the first camera 405a and deactivating the second camera 405b. Also, the medium may include instructions executable by the processor 404 to activate the first camera 405a and deactivate the second camera 405b, so that the first camera is operable to capture an image and the second camera is not operable to capture an image. This can occur where the user interaction matches the one of the set of user interactions with the touchscreen 407 indicative of activating the first camera 405a and deactivating the second camera 405b.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only with a true scope and spirit of the invention being indicated by the following claims.

It should be appreciated that the present invention is not limited to the exact construction that has been described above and illustrated in the accompanying drawings, and that various modifications and changes can be made without departing from the scope thereof. It is intended that the scope of the invention should only be limited by the appended claims.

1. A method for switching between cameras of a mobile device, comprising:
receiving, at control circuitry of a mobile device, user-inputted instructions to activate a first camera of the mobile device, so that the first camera is operable to capture an image;
receiving, at the control circuitry, touch instructions from a touchscreen of the mobile device indicative of a user interaction with the touchscreen that does not correspond to an icon or another type of graphical element displayed proximate to the user interaction;
determining, by the control circuitry, whether the user interaction with the touchscreen matches one of a predetermined set of user interactions with the touchscreen indicative of activating a second camera and deactivating the first camera, the set of user interactions stored in a memory device of the mobile device; and
where the user interaction matches the one of the set of user interactions with the touchscreen indicative of activating the second camera and deactivating the first camera:
activating, by the control circuitry, the second camera so that the second camera is operable to capture an image; and
deactivating, by the control circuitry, the first camera so that the first camera is not operable to capture an image.

2. The method of claim 1, wherein the user-inputted instructions to activate the first camera of the mobile device are also indicative of a touchscreen gesture that does not correspond to an icon or another type of graphical element displayed proximate to the gesture.

3. The method of claim 1, further comprising:
wherein the touch instructions are first touch instructions and the user interaction is a first user interaction, receiving, at the control circuitry, second touch instructions from the touchscreen of the mobile device indicative of a second user interaction with the touchscreen that does not correspond to an icon or another type of graphical element displayed proximate to the second user interaction;
determining, by the control circuitry, whether the second user interaction with the touchscreen matches one of the set of user interactions with the touchscreen indicative of activating the first camera and deactivating the second camera; and
activating, by the control circuitry, the first camera and deactivating the second camera so that the first camera is operable to capture an image and the second camera is not operable to capture an image, where the second user interaction matches the one of the set of user interactions with the touchscreen indicative of activating the first camera and deactivating the second camera.

4. The method of claim 3, wherein the one of the set of user interactions with the touchscreen indicative of activating the second camera and deactivating the first camera and the one of the set of user interactions with the touchscreen indicative of activating the first camera and deactivating the second camera include a vertical swipe across the touchscreen.

5. The method of claim 3, wherein the one of the set of user interactions with the touchscreen indicative of activating the second camera and deactivating the first camera and the one of the set of user interactions with the touchscreen indicative of activating the first camera and deactivating the second camera are similar user interactions.

6. The method of claim 3, wherein the one of the set of user interactions with the touchscreen indicative of activating the second camera and deactivating the first camera and the one of the set of user interactions with the touchscreen indicative of activating the first camera and deactivating the second camera are different user interactions.

7. The method of claim 3, wherein the one of the set of user interactions with the touchscreen indicative of activating the second camera and deactivating the first camera, the one of the set of user interactions with the touchscreen indicative of activating the first camera and deactivating the second camera, or both are configurable by a user of the mobile device.

8. The method of claim 1, wherein the one of the set of user interactions with the touchscreen indicative of activating the second camera and deactivating the first camera includes continually touching the touchscreen for at least a certain duration of time.

9. The method of claim 1, wherein the one of the set of user interactions with the touchscreen indicative of activating the second camera and deactivating the first camera includes touch gesturing a two-dimensional shape on the touchscreen.

10. The method of claim 1, wherein the one of the set of user interactions with the touchscreen indicative of activating the second camera and deactivating the first camera includes a swipe on the touchscreen.

11. The method of claim 10, wherein the swipe is at least a certain length.

12. The method of claim 10, wherein the swipe is at a certain portion of the touchscreen.

13. The method of claim 10, wherein the swipe is in a certain direction.

14. The method of claim 1, wherein the one of the set of user interactions with the touchscreen indicative of activating the second camera and deactivating the first camera includes a certain frequency of touches at a same portion of the touchscreen.

15. A mobile device, comprising: a touchscreen; a first camera; a second camera; a memory device; a processor; and
control circuitry that includes at least part of the memory device and the processor, the control circuitry configured to:
receive user-inputted instructions to activate a first camera of the mobile device, so that the first camera is operable to capture an image, the user-inputted instructions to activate the first camera of the mobile device being indicative of a touchscreen gesture that does not correspond to an icon or another type of graphical element displayed proximate to the gesture;
receive touch instructions from a touchscreen of the mobile device indicative of a user interaction with the touchscreen that does not correspond to an icon or another type of graphical element displayed proximate to the user interaction;
determine whether the user interaction with the touchscreen matches one of a set of user interactions with the touchscreen indicative of activating a second camera and deactivating the first camera, the set of user interactions stored in the memory device; and
where the user interaction matches the one of the set of user interactions with the touchscreen indicative of activating the second camera and deactivating the first camera:
activate the second camera so that the second camera is operable to capture an image; and
deactivate the first camera so that the first camera is not operable to capture an image.

16. The mobile device of claim 15, wherein the touch instructions are first touch instructions and the user interaction is a first user interaction, and wherein the control circuitry is further configured to:
receive second touch instructions from the touchscreen of the mobile device indicative of a second user interaction with the touchscreen that does not correspond to an icon or another type of graphical element displayed proximate to the second user interaction;
determine whether the second user interaction with the touchscreen matches one of the set of user interactions with the touchscreen indicative of activating the first camera and deactivating the second camera; and
activate the first camera and deactivate the second camera so that the first camera is operable to capture an image and the second camera is not operable to capture an image, where the user interaction matches the one of the set of user interactions with the touchscreen indicative of activating the first camera and deactivating the second camera.

17. The mobile device of claim 15, wherein the first camera is a rear-facing camera and the second camera is a front-facing camera.

18. The mobile device of claim 15, wherein the first camera is a front-facing camera and the second camera is a rear-facing camera.

19. The mobile device of claim 15, wherein the first and second cameras are rear-facing cameras or wherein the first and second cameras are front-facing cameras.

20. A non-transitory computer readable medium, comprising:
instructions executable by a processor to receive user-inputted instructions to activate a first camera of a mobile device, so that the first camera is operable to capture an image, the user-inputted instructions to activate the first camera of the mobile device being indicative of a touchscreen gesture that does not correspond to an icon or another type of graphical element displayed proximate to the gesture;
instructions executable by a processor to receive touch instructions from a touchscreen of the mobile device indicative of a user interaction with the touchscreen that does not correspond to an icon or another type of graphical element displayed proximate to the gesture;
instructions executable by a processor to determine whether the user interaction with the touchscreen matches one of a set of user interactions with the touchscreen indicative of activating a second camera and deactivating the first camera, the set of user interactions stored in a memory device of the mobile device; and
instructions executable by a processor to activate the second camera and deactivating the first camera so that the second camera is operable to capture an image and the first camera is not operable to capture an image, where the user interaction matches the one of the set of user interactions with the touchscreen indicative of activating the second camera and deactivating the first camera.
